(19) United States
(12) Patent Application Publication
(10) Pub. No.: US 2025/0309327 A1
(43) Pub. Date: Oct. 2, 2025

(54) PREHEATING APPARATUS AND METHOD OF MANUFACTURING ALL-SOLID-STATE BATTERY INCLUDING PREHEATING PROCESS USING THE SAME

(71) Applicants: HYUNDAI MOTOR COMPANY, SEOUL (KR); KIA CORPORATION, SEOUL (KR); SAMSUNG SDI CO., LTD., YONGIN-SI (KR)

(72) Inventors: Jae Ho Chun, Suwon-si (KR); Hyoup Je Cho, Suwon-si (KR); Jeong Hoon Kim, Yongin-si (KR); Man Soo Shin, Yongin-si (KR)

(73) Assignees: HYUNDAI MOTOR COMPANY, SEOUL (KR); KIA CORPORATION, SEOUL (KR); SAMSUNG SDI CO., LTD., YONGIN-SI (KR)

(21) Appl. No.: 18/939,924

(22) Filed: Nov. 7, 2024

(30) Foreign Application Priority Data
Mar. 28, 2024 (KR) 10-2024-0042464

(51) Int. Cl. H01M 10/04; H01M 4/04; H01M 4/139

(52) U.S. Cl. CPC H01M 10/0481; H01M 4/0404; H01M 4/0471; H01M 4/139; H01M 2300/0065

(57) ABSTRACT

A warm isostatic pressing (WIP) process occurs during manufacture of an all-solid-state battery. A warm isostatic pressing (WIP) system includes a preheating apparatus configured to preheat cells, in which a cathode, an anode, and a solid electrolyte are stacked, to a predetermined temperature, and a vessel configured to perform the warm isostatic pressing (WIP) process on the preheated cells.

### CROSS REFERENCE TO RELATED APPLICATIONS

This application claims under 35 U.S.C. § 119(a) the benefit of priority to Korean Patent Application No. 10-2024-0042464, filed on Mar. 28, 2024, the entire contents of which are incorporated herein by reference.

### TECHNICAL FIELD

The present disclosure relates to manufacture of an all-solid-state battery. More particularly, it relates to a warm isostatic pressing process during manufacture of an all-solid-state battery.

### BACKGROUND

Recently, application of rechargeable secondary batteries is expanding in various fields, from small electronic devices to large energy storage systems. Particularly, research and development on secondary batteries is being actively conducted due to rapid growth of the electric vehicle market.

Lithium-ion batteries are mainly used as secondary batteries, but recently, next-generation batteries, such as all-solid-state batteries, are attracting attention. Particularly, all-solid-state batteries including a solid electrolyte have an advantage in terms of safety.

Secondary batteries are manufactured through an electrode process, an assembly process, and an activation process. However, unlike lithium-ion batteries, all-solid-state batteries require a warm isostatic pressing (WIP) process in the assembly process.

As shown in FIG. 1, in case of an all-solid-state battery, voids 6 exist between an electrode active material 2 and a solid electrolyte 4. Because the ionic conductivity of the solid electrolyte 4 is lower than that of a liquid electrolyte of a lithium-ion battery, the purpose of the WIP process is to minimize the voids 6 existing in electrodes and cells through warm isostatic pressing of the solid electrolyte 4 to densify a unit cell 10. As shown in FIG. 2, the unit cell 10 pressed through the WIP process includes a cathode layer 12, a solid electrolyte layer 14, and an anode layer 16, and the unit cell 10 of the all-solid-state battery is manufactured by stacking these layers 12, 14 and 16 to suit a required capacity.

The above information disclosed in this Background section is only for enhancement of understanding of the background of the disclosure and therefore it may contain information that does not form the prior art that is already known to a person of ordinary skill in the art.

### SUMMARY

The present disclosure has been made in an effort to solve the above-described problems associated with the prior art, and it is an object of the present disclosure to provide a preheating apparatus for an all-solid-state battery and a WIP system including the same, which may prevent process efficiency from decreasing due to heat loss before a WIP process when manufacturing the all-solid-state battery.

It is another object of the present disclosure to provide a battery manufacturing system including the preheating apparatus and the WIP system including the same.

It is yet another object of the present disclosure to provide a method of manufacturing an all-solid-state battery including a preheating process.

The objects of the present disclosure are not limited to the above-mentioned objects, and other objects not mentioned herein will be clearly understood by persons of ordinary skill in the art to which the present disclosure pertains (referred to as “those skilled in the art”) from the following description.

In one aspect, the present disclosure provides a warm isostatic pressing (WIP) system including a preheating apparatus configured to preheat one or more cells, in which a cathode, an anode, and a solid electrolyte are stacked, to a predetermined temperature, and a vessel configured to perform a warm isostatic pressing (WIP) process on the preheated cells.

In another aspect, the present disclosure provides a method of manufacturing an all-solid-state battery, including preheating one or more cells, in which electrodes including a cathode and an anode, and a solid electrolyte are stacked, to a predetermined temperature by a preheating apparatus, and performing a warm isostatic pressing (WIP) process on the preheated cells within a vessel.

Other aspects and preferred embodiments of the disclosure are discussed infra.

### BRIEF DESCRIPTION OF THE FIGURES

The above and other features of the present disclosure will now be described in detail with reference to certain embodiments thereof illustrated in the accompanying drawings which are given hereinbelow by way of illustration only, and thus are not limitative of the present disclosure, and wherein:

FIG. 1 is a diagram showing voids existing between an electrode material and a solid electrolyte of an all-solid-state battery;

FIG. 2 shows schematic cross-sectional views of an all-solid-state battery before and after a warm isostatic pressing process;

FIG. 3 shows a WIP system according to one embodiment of the present disclosure;

FIG. 4 is a perspective view showing a preheating apparatus and a transfer apparatus according to one embodiment of the present disclosure;

FIG. 5 is a front view showing the preheating apparatus and the transfer apparatus according to one embodiment of the present disclosure;

FIG. 6 is a front view of the preheating apparatus, from which a case is removed, according to one embodiment of the present disclosure;

FIG. 7 is a rear view of the preheating apparatus, from which the case is removed, according to one embodiment of the present disclosure;

FIG. 8 is a side view of the preheating apparatus, from which the case is removed, according to one embodiment of the present disclosure;

FIG. 9 is a perspective view of the preheating apparatus, from which the case is removed, according to one embodiment of the present disclosure;

FIG. 10 is a view showing a holder of the preheating apparatus according to one embodiment of the present disclosure;

FIG. 11 is a perspective view of the transfer apparatus according to one embodiment of the present disclosure;

FIG. 12 is a front view of the transfer apparatus according to one embodiment of the present disclosure;

FIG. 13 is a view showing operation of a lift of the preheating apparatus according to one embodiment of the present disclosure; and

FIGS. 14 and 15 are views showing a preheating apparatus according to another embodiment of the present disclosure.

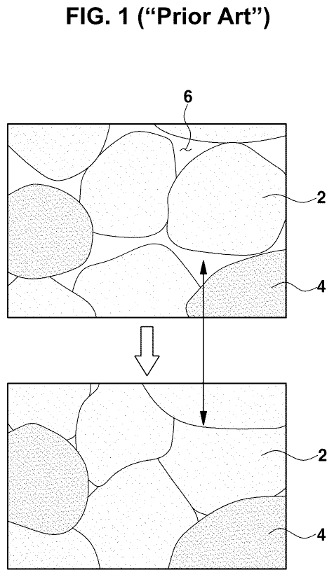

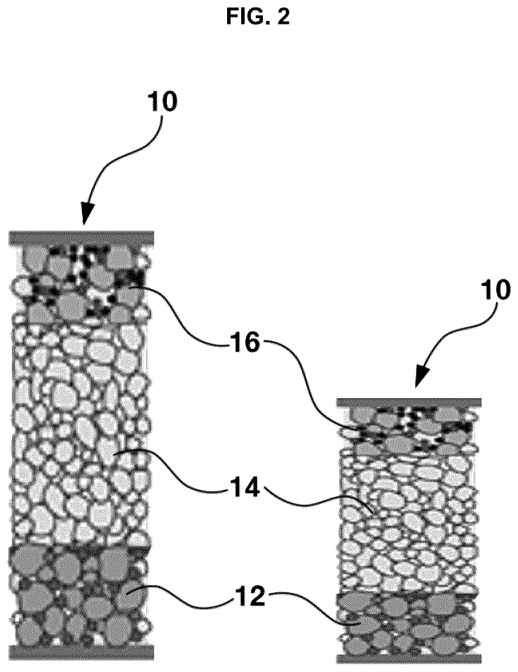

### DETAILED DESCRIPTION

Specific structural or functional descriptions in embodiments of the present disclosure set forth in the description which follows will be exemplarily given to describe the embodiments of the present disclosure, and the present disclosure may be embodied in different forms. Further, it will be understood that the present disclosure should not be construed as being limited to the embodiments set forth herein, and the embodiments of the present disclosure are provided only to completely disclose the disclosure and cover modifications, equivalents or alternatives which come within the scope and technical range of the disclosure.

In the following description of the embodiments, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the drawings to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

Hereinafter, the present disclosure will be described in detail with reference to the accompanying drawings.

As described above, secondary batteries may be manufactured through the electrode process, the assembly process, and the activation process. In the electrode process, electrodes are manufactured through a mixing process, a coating process, a slitting process, and a pressing process. In the mixing process, an electrode including a cathode or an anode is prepared by mixing electrode materials. The electrode materials include an electrode active material, a conductive material, and a binder. For example, in the mixing process, a cathode is prepared by mixing a cathode active material, a conductive material, and a binder, and an anode is prepared by mixing an anode active material, a conductive material, and a binder. The cathode and anode prepared in this way are coated on foils, for example, aluminum foil and copper foil, respectively. Further, in the slitting process, the electrodes are cut to predetermined sizes, and in the pressing processes, the cut electrodes are pressed to be flattened through a roll press.

In the assembly process, the electrodes manufactured in the electrode process take the form of a battery. Electrode tabs are formed through a notching process, and the electrodes are dried through a drying process. Thereafter, the cathode, the anode, and a solid electrolyte are stacked through a stacking process.

The activation process includes the activation process and an aging process in which charging and discharging of the battery are repeated. Further, evaluation and inspection of the manufactured battery are performed.

Particularly, unlike secondary batteries, such as lithium-ion batteries, which use a liquid electrolyte, the warm isostatic pressing (WIP) process is required in the assembly process of all-solid-state batteries. The WIP process may be performed during the stacking process. In the WIP process, voids in the electrodes and cells may be densified through warm isostatic pressing.

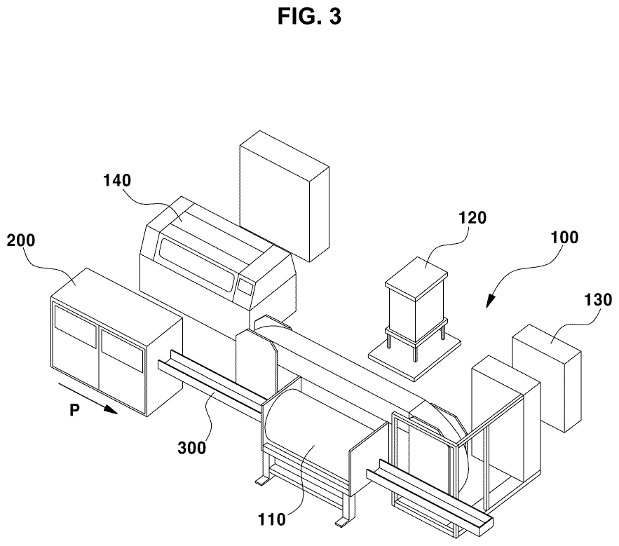

As shown in FIG. 3, a battery cell 10 which has undergone some of the above-described electrode process and assembly process is pressed at a relatively high temperature and high pressure in the WIP process. For this purpose, a WIP system 100 includes a vessel 110. Before starting the WIP process, the vessel 110 is heated to a high temperature, e.g., 100° C. or higher. After the cell 10 mounted on a jig is inserted into the vessel 110, the WIP process is performed. In the WIP process, the all-solid-state battery is pressed at a temperature of 80 to 100° C. and a pressure of 4,000 to 6,000 bar. At this time, since the cell 10 mounted on the jig kept at room temperature (25° C.) is inserted into the vessel 110, the temperature inside the vessel 110 decreases, and reheating is necessary due to heat loss. This reheating process has the disadvantage of lowering process efficiency.

More specifically, water is supplied to the vessel 110 by a high pressure pump 140 to create required pressure. When the cell 10 mounted on the jig is inserted into the vessel 110, water of about 80° C. is supplied by a water tank 120. At this time, the vessel 110 is at a temperature of about 10° C. When the cell 10 at room temperature is inserted into the vessel 110, the temperature of the supplied water supplied, i.e., 80° C., falls to about 70° C. or lower. Further, the temperature of the vessel 110 heated to about 109° C. by an oil heater 130 also falls. Since the WIP process is performed at 80° C., the supplied water is heated by the heat of the vessel 110. For this reason, time loss occurs because the process may not be started immediately after the cell 10 is inserted into the vessel 110.

Accordingly, the present disclosure proposes a preheating apparatus for an all-solid-state battery and a method of manufacturing the all-solid-state battery including a preheating process of the all-solid-state battery, which may prevent process efficiency from decreasing by preheating the all-solid-state battery before the WIP process.

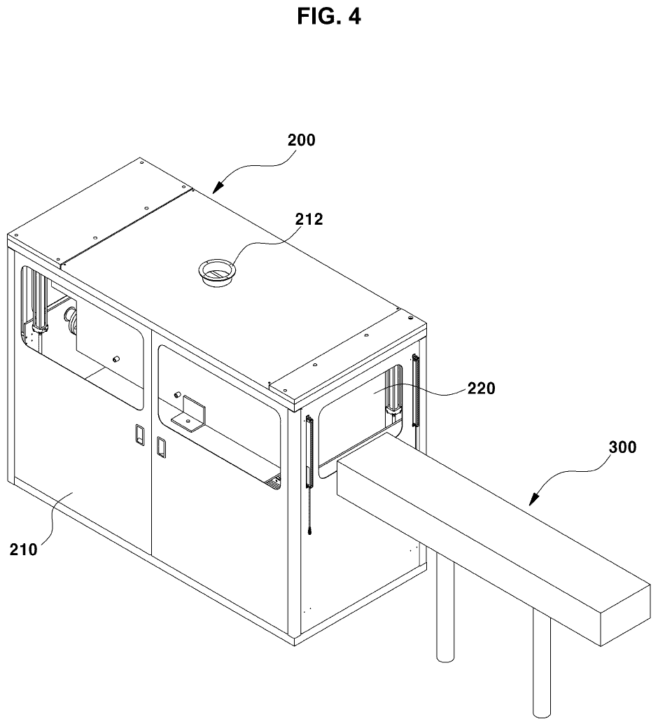

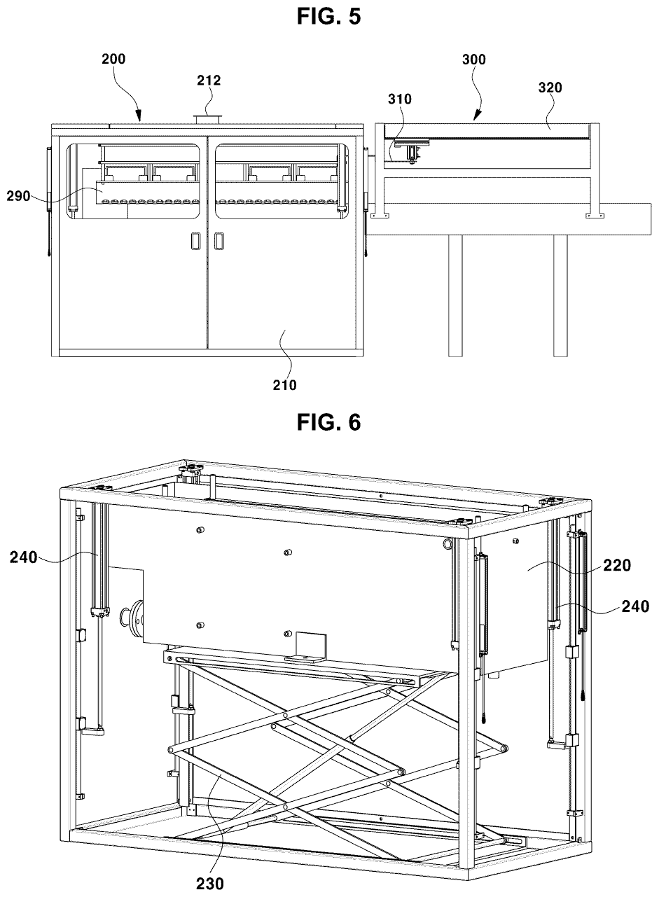

Referring to FIGS. 4 and 5, the WIP system 100 according to the present disclosure includes a preheating apparatus 200. According to one embodiment of the present disclosure, the preheating apparatus 200 may be a water tank preheating-type apparatus which heats the cell 10 of the all-solid-state battery and the jig using hot water in a water tank. According to another embodiment of the present disclosure, the preheating apparatus 200 may be an apparatus which preheats the cell of the all-solid-state battery and the jig by applying hot air thereto.

The preheating apparatus 200 may include a case 210. The case 210 may protect preheating mechanisms of the preheating apparatus 200. In some implementation examples, a portion of the case 210 may be transparent or may have an opening so that operation of the preheating apparatus 200 may be observed from the outside. In addition, the case 210 may be provided with an exhaust duct 212. The exhaust duct 212 may discharge water vapor generated from the inside of the case 210 to the outside.

As shown in FIG. 6, the preheating apparatus 200 includes a container 220 and a lift 230. The container 220 may accommodate a liquid, such as water, and the cell 10 mounted on the jig may be placed in the container 220 so that the temperature of the cell 10 may be raised.

The container 220 may be movably mounted on the lift 230. In some implementation examples, the lift 230 may support the container 220 to raise or lower the container 220. The driving force of the lift 230 may be provided by a driving device. In the illustrated example of implementation, the lift 230 may be raised or lowered by a cylinder 240, such as an electric or pneumatic cylinder.

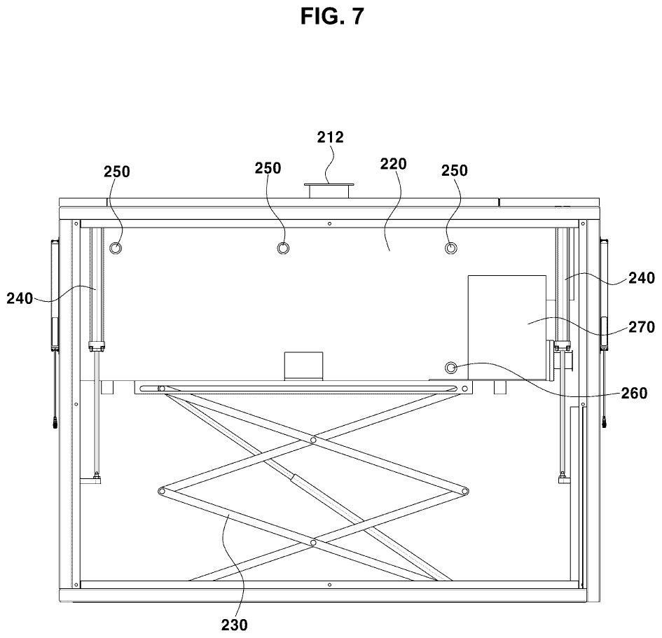

Referring to FIG. 7, the container 220 may be provided with one or more supply lines 250 and one or more drain lines 260. Water may be supplied into the container 220 through the one or more supply lines 250, and water in the container 220 may be discharged through the one or more drain lines 260.

Further, the preheating apparatus 200 may include a control panel 270. The control panel 270 may control operation of the preheating apparatus 200. The control panel 270 may be arranged in the preheating apparatus 200 itself, as shown in the illustrated example of implementation, or may be provided outside the preheating apparatus 200 through wired or wireless connection.

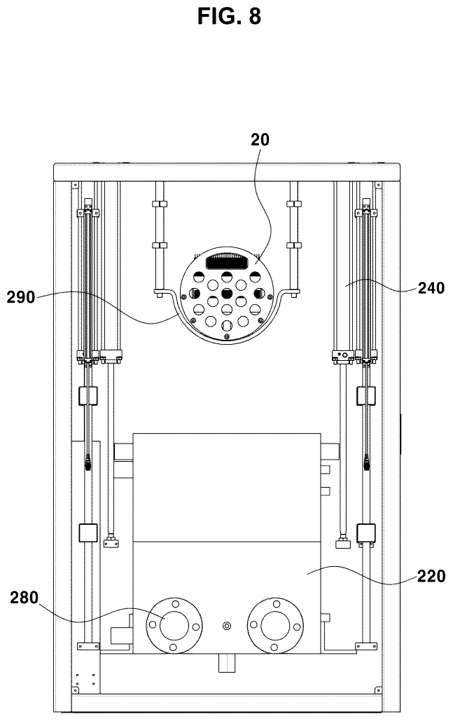

As shown in FIG. 8, the preheating apparatus 200 may include a heater 280. The temperature of hot water in the container 220 may be raised by operation of the heater 280, and the water in the container 220 may be preheated to a usage temperature in advance.

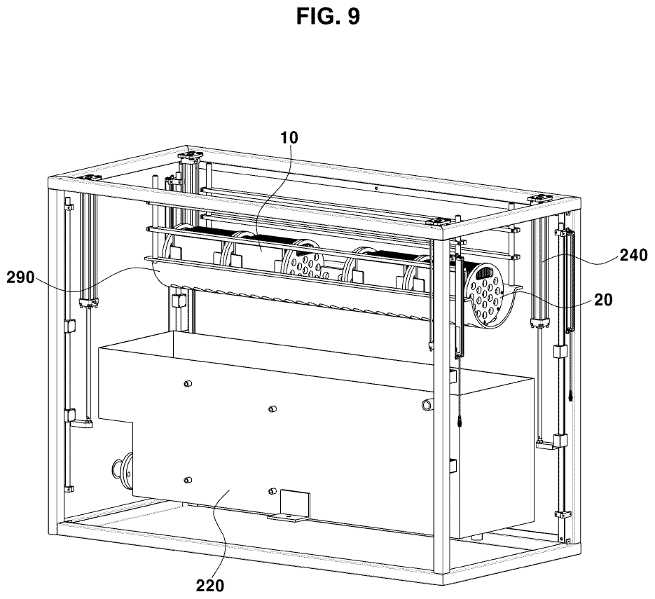

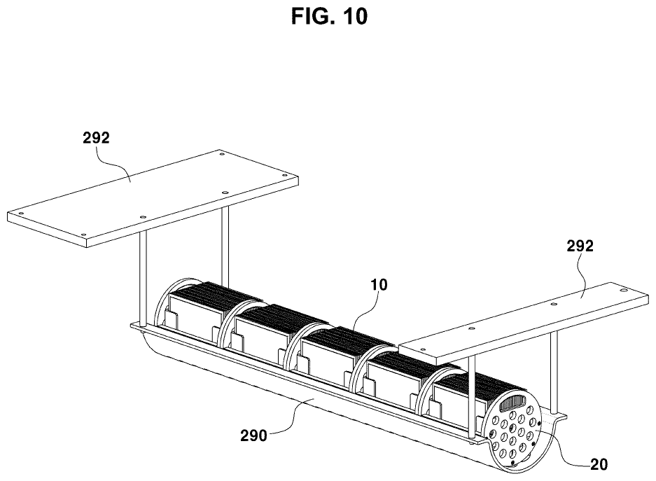

Additionally referring to FIG. 9, the preheating apparatus 200 may include a holder 290. The holder 290 is configured to support the cell 10 mounted on the jig, which is a target to be preheated, during operation of the preheating apparatus 200. Since the container 220 is configured to move up and down in the case 210, the holder 290 may be suspended at the inner upper surface of the case 210. As shown in FIG. 10, the holder 290 may be suspended from the upper surface of the case 210 by panel-type fixing parts 292.

In some examples of implementation, the lift 230 may be omitted. Instead, the container 220 is fixed to the ground, or the like, and the holder 290 may be configured to be movable up and down by a driving device, such as a cylinder, so that a basket 20 accommodating the cell 10 moves into the container 220.

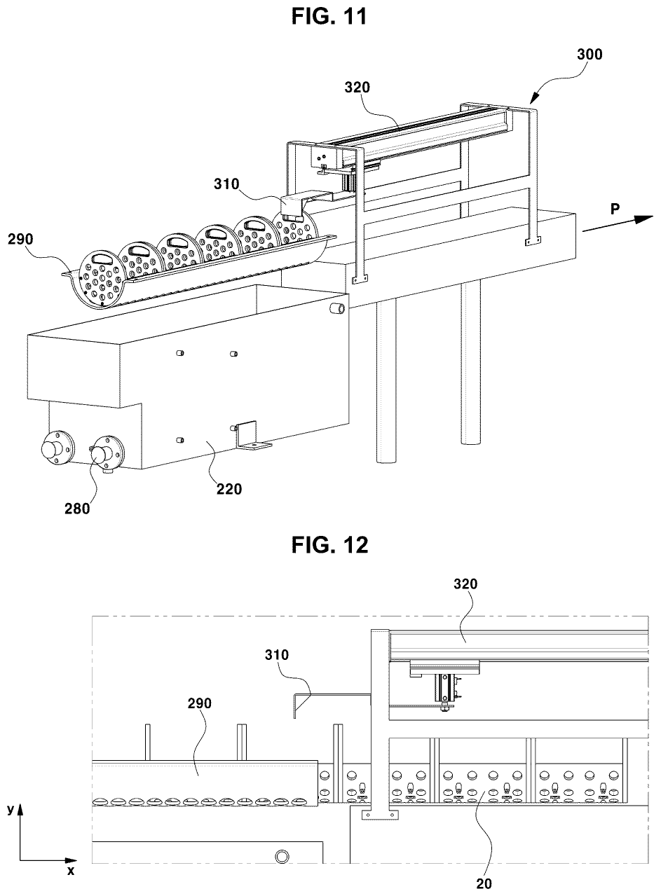

Referring to FIGS. 11 and 12, the WIP system 100 may further include a transfer apparatus 300. That is, the preheating apparatus 200 may be integrated with the WIP system 100. The transfer apparatus 300 may automatically transfer the cell 10 mounted on the jig, which have been preheated through the preheating apparatus 200, to the vessel 110 for a subsequent process, i.e., the WIP process. In some examples of implementation, the preheating apparatus 200 may be provided separately from the WIP system 100.

The transfer apparatus 300 may include a gripper 310 and a transporter 320. The gripper 310 may grip the basket 20 on which one or more cells 10 are mounted within the holder 290. The gripper 310 may be mounted on the transporter 320 and may move left and right (in the x-axis direction) and up and down (in the y-axis direction). The gripper 310 may grip the basket 20 and may tow the basket 20 by the transporter 320. After gripping a proximal portion of the basket 20 so that a portion of the basket 20 is moved in a process direction P toward the vessel 110, the gripper 310 may reenter the holder 290 and grip another portion of the basket 20 so that the remaining portion of the basket 20 may be transported to the vessel 110 through a conveyer belt or the like.

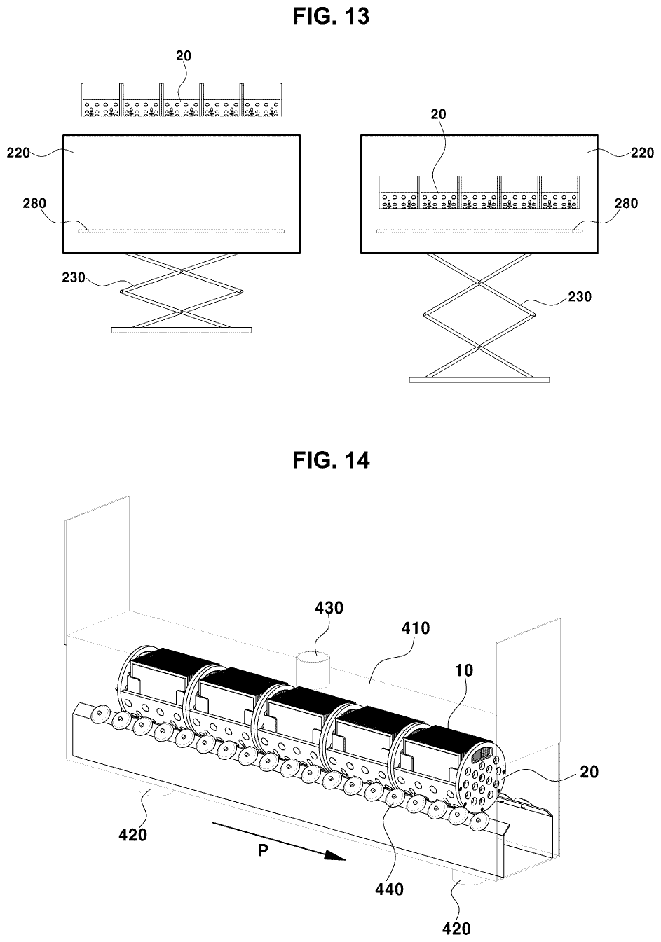

Referring to FIG. 13, the preheating apparatus 200 may operate as follows. When the one or more cells 10 contained in the basket 20 enter the holder 290, the container 220 is moved downward by driving the lift 230. When preheating, the container 220 is moved upward by the lift 230, and the cells 10, which are the target to be preheated, are accommodated in the container 220. The cells 10 within the basket 20 heated to a predetermined preheating temperature are heated by the heater 280 for a predetermined time, so the cells 10 may have an appropriate temperature required when discharged from the preheating apparatus 200. Here, the predetermined preheating temperature may be the same as a temperature condition of the WIP process. In some embodiments, the temperature condition of the WIP process may be in a range of 80 and 100° C., as described above. In some embodiments, the temperature condition of the WIP process may be about 80° C. In some examples of implementation, a water level sensor and a temperature sensor may be provided in the container 220 to monitor the level and temperature of the water in the container 220.

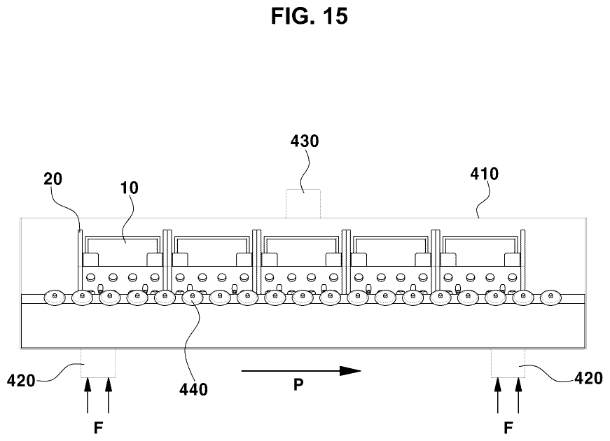

As shown in FIGS. 14 and 15, according to another embodiment of the present disclosure, a preheating apparatus 400 may perform heating by hot air. The preheating apparatus 400 may include an enclosure 410 configured such that hot air is supplied into the enclosure 410. The enclosure 410 is configured such that both ends of the enclosure 410 are openable. One or more cells 10 to be preheated may enter and exit the enclosure 410 through the ends of the enclosure 410.

In some examples of implementation, one or more fluid inlets 420, through which hot air is supplied into the enclosure 510, may be provided at the lower part of the enclosure 410, and a fluid having passed through the enclosure 410 may be discharged to the outside of the enclosure 410 through one or more fluid outlets 430 provided at the upper part of the enclosure 410. As a non-limiting example, the fluid may be heated air.

In some examples of implementation, a moving portion 440 is provided within the enclosure 410. For example, the moving portion 440 may include a plurality of rollers, a conveyer belt, or the like, to which power is supplied. A basket 20 heated by hot air within the enclosure 410 may be automatically taken out of the enclosure 410 through the moving portion 440.

Like the preheating apparatus 200, the preheating apparatus 400 may also move the preheated cells 10 to the vessel 110 through the transfer apparatus 300. A detailed description of redundant contents will be omitted.

The assembly process of the cells 10, which have undergone the preheating process and the WIP process according to the present disclosure, is completed through additional processes, i.e., the stacking process and the packaging process. After completing the assembly process, manufacture of the all-solid-state battery may be completed through the activation process. In addition, modularization of the manufactured all-solid-state battery cells may be done depending on the purpose of use.

According to the present disclosure, efficiency of the WIP process may be improved by preheating the cells of the all-solid-state battery and the jig in advance.

Further, according to the present disclosure, an automation rate may be improved through automation of the preheating process.

As is apparent from the above description, according to the present disclosure, a preheating apparatus for an all-solid-state battery and a WIP system including the same, which may prevent process efficiency from decreasing due to heat loss before a WIP process when manufacturing the all-solid-state battery, are provided.

According to the present disclosure, a battery manufacturing system including the preheating apparatus and the WIP system including the same is provided.

In addition, according to the present disclosure, a method of manufacturing an all-solid-state battery including a preheating process is provided.

The effects of the present disclosure are not limited to the above-described effects, and other effects not mentioned herein will be clearly understood by those skilled in the art from the above description.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. A warm isostatic pressing (WIP) system comprising:
a preheating apparatus configured to preheat one or more cells to a predetermined temperature, wherein a cathode, an anode, and a solid electrolyte are stacked in each of the one or more cells; and
a vessel configured to perform a warm isostatic pressing (WIP) process on the one or more preheated cells.

2. The WIP system of claim 1, wherein the preheating apparatus is configured to preheat the one or more cells by a heated fluid supplied to the preheating apparatus.

3. The WIP system of claim 1, wherein the predetermined temperature is the same as a temperature condition of the WIP process.

4. The WIP system of claim 1, wherein the preheating apparatus comprises:
a container configured to accommodate a liquid and to be heatable;
a lift configured such that the container is mounted on the lift to be movable up and down; and
a holder configured to be positioned in the container by movement of the lift, and the holder further configured to accommodate the one or more cells.

5. The WIP system of claim 4, wherein the preheating apparatus further comprises a heater, and wherein the container is heatable by the heater.

6. The WIP system of claim 1, wherein the preheating apparatus comprises:
an enclosure configured to receive a heated fluid; and
a moving portion positioned in the enclosure and configured to move the one or more cells inserted into the enclosure.

7. The WIP system of claim 6, wherein the enclosure comprises one or more fluid inlets configured such that the heated fluid flows into the enclosure through the one or more fluid inlets, and one or more fluid outlets configured such that the fluid passing through the enclosure is discharged through the one or more fluid outlets.

8. The WIP system of claim 1, further comprising a transfer apparatus configured to transfer the one or more cells preheated by the preheating apparatus to the vessel.

9. The WIP system of claim 8, wherein the transfer apparatus comprises:
a gripper configured to grip the one or more cells and to move the one or more cells in a first direction and a second direction perpendicular to the second direction; and
a transporter configured to provide a moving force to the gripper.

10. The WIP system of claim 1, wherein, in the WIP process, the one or more cells are pressed at a temperature in a range of 80° C. to 100° C., and a pressure in a range of 4,000 bar to 6,000 bar within the vessel.

11. A method of manufacturing an all-solid-state battery, comprising:
preheating one or more cells to a predetermined temperature by a preheating apparatus, wherein electrodes comprising a cathode and an anode and a solid electrolyte are stacked in each of the one or more cells; and
performing a warm isostatic pressing (WIP) process on the preheated one or more cells within a vessel.

12. The method of claim 11, wherein the preheating apparatus preheats the one or more cells by supplying a heated fluid to the preheating apparatus.

13. The method of claim 11, wherein the predetermined temperature is a same as a temperature condition of the WIP process.

14. The method of claim 11, further comprising, before preheating the one or more cells, performing an electrode process comprising a mixing process of mixing electrode materials for the electrodes and a coating process of coating the mixed electrode materials.

15. The method of claim 14, further comprising performing an assembly process comprising stacking the electrodes and the solid electrolyte, preheating the one or more cells, and performing the WIP process.

16. The method of claim 15, further comprising, after performing the assembly process, performing an activation process of the cells.

17. The method of claim 11, wherein the preheating apparatus comprises:
a container configured to accommodate a liquid and to be heatable;
a lift configured such that the container is mounted on the lift to be movable up and down; and
a holder configured to be positioned in the container by movement of the lift and accommodate the one or more cells.

18. The method of claim 11, wherein the preheating apparatus comprises:
an enclosure configured to receive a heated fluid; and
a moving portion positioned in the enclosure and configured to move the one or more cells inserted into the enclosure.

19. The method of claim 11, further comprising transferring, by a transfer apparatus, the preheated one or more cells to the vessel.

20. The method of claim 11, wherein, in the WIP process, the one or more cells are pressed at a temperature in a range of 80° C. to 100° C., and a pressure in a range of 4,000 bar to 6,000 bar within the vessel.
